(19) United States
(12) Patent Application Publication
(10) Pub. No.: US 2006/0223499 A1
(43) Pub. Date: Oct. 5, 2006

(54) Broadcast subscription management method and apparatus

(76) Inventors: Mark E. Pecen, Palatine, IL (US); Kenneth A. Stewart, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 11/094,062

(22) Filed: Mar. 30, 2005

(51) Int. Cl. H04M 11/00

(52) U.S. Cl. 455/411

(57) ABSTRACT

A method and apparatus for broadcast subscription management in a mobile station (110) comprises sending (302) a subscriber identifier, which may be for example an international mobile station identifier and a radio receiver identification with a transmitter of the mobile station to a wireless communications network (100). The mobile station receives, from a Broadcast Network Operator (187), through the wireless communications network, a shared secret key. The mobile station authenticates (306) a broadcast radio receiver of the mobiles station or broadcast data received from the broadcast network operator with the shared secret key.

### FIELD OF THE INVENTIONS

The present inventions relate generally to wireless communications, and more particularly to a method and apparatus for the management of subscription broadcast services across multiple devices.

### BACKGROUND OF THE INVENTIONS

Mobile wireless communications subscriber devices and cellular subscriber communications networks are increasingly providing and supporting technologies that enable content download and streaming for entertainment, e-commerce services, applications etc.

Broadcast subscription services that provide content to a subscriber terminal such as subscription radio services (e.g. Sirius Satellite Radio® or XM® Satellite Radio services) or satellite television services for example, generally manage subscriptions on a per terminal basis, i.e. the subscription is logically bound to a single hardware device. Access to these services cannot be seamlessly transferred from one subscriber terminal to another.

Additionally, the services are generally encrypted in order to prevent piracy and protect subscription revenue. However this requires the user to activate the device in order to authenticate and enable the receiver to receive the encrypted broadcast. One solution requires subscriber intervention in which the subscriber must contact the broadcast subscription service provider and present a radio hardware identification.

The increasing popularity of broadcast subscription services has led to the convergence of broadcast receivers with other portable terminals. For example, satellite broadcast receivers are being incorporated into mobile cellular terminals. Although these are portable devices, the subscription services cannot be seamlessly transferred from one device to another as a result of the legacy subscription activation method. The subscription is associated with the receiver identification of the terminal.

The various aspects, features and advantages of the present inventions will become more fully apparent to those having ordinary skill in the art upon careful consideration of the following Detailed Description of the Drawings with the accompanying drawings described below.

### BRIEF DESCRIPTION OF THE DRAWINGS

FIG. 1 is an exemplary wireless communications network.

FIG. 2 is an exemplary communications device.

FIG. 3 is an exemplary communications flow diagram.

FIG. 4 is an exemplary communications exchange ladder between a mobile station and a network.

FIG. 5 is another exemplary communications exchange ladder between a mobile station and a network.

FIG. 6 is an exemplary communications flow chart.

### DETAILED DESCRIPTION OF THE DRAWINGS

A method for automatic user mobility management of broadcast subscription services is disclosed. The method comprises transmitting a subscription request from a mobile station, the subscription request including a subscriber identity and a radio receiver identification to a network such as a cellular radiotelephone network or the like. In response to the request, the mobile station receives a shared secret key from the network. The mobile station authenticates, with the shared secret key, a broadcast radio receiver of the mobile station which is associated with the radio receiver identification. The subscription may follow the subscriber ID from device to device automatically.

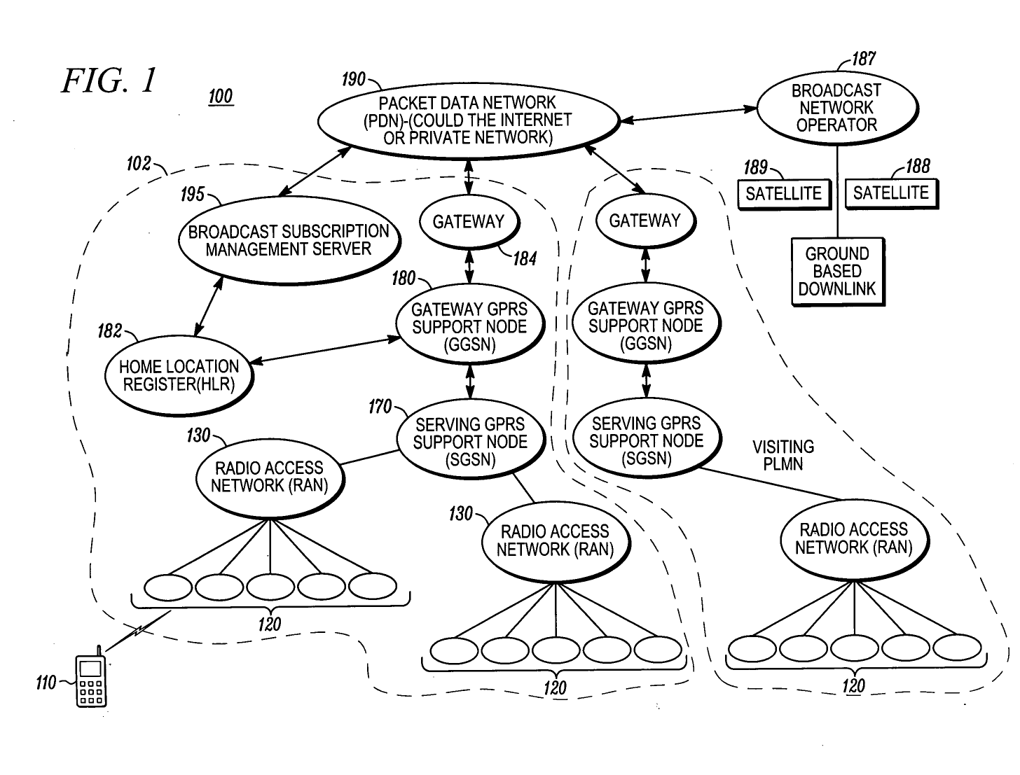

FIG. 1 illustrates an exemplary wireless communications network in the form of a Global System for Mobile communications (GSM) network 100 supporting wireless communications for mobile wireless communication devices, for example, mobile station (MS) 110, also referred to herein as a mobile wireless communications device, user equipment or user terminal.

The mobile wireless communications device may be a wireless cellular telephone, or a two-way pager, or a wireless enabled personal digital assistant (PDA) or notebook or laptop computer, PC card or some other radio communications device, any of which may be a cellular communications service subscriber device.

The exemplary network 100 generally includes a plurality of base-station transceivers (BTS) 120 that communicate with a Radio Access Network (RAN) 130, which communicates with a Serving GPRS Switching Node (SGSN) 170. The SGSN 170 is communicably coupled to a Gateway GPRS Support Node (GGSN) 180 which is communicably coupled to a Home Location Register (HLR) 182 and a gateway 184 all of which form a Public Land Mobile Network (PLMN) 102 which in this exemplary embodiment couples to a packet data network (PDN) 190 (e.g. the internet). These and other aspects of GSM and other communications network architectures are known generally. The MS 110 in this exemplary embodiment communicates with the exemplary network through at least one of the BTS 120. The MS 110 may be communicating with one of the plurality of BTS 120 which are a part of the PLMN 102 or the MS 110 may be communicating with multiple BTS's 120 simultaneously such as in a code division multiple access (CDMA) system.

Broadcast services that provide content to users or subscribers through wireless terminals are generally known for providing audio and video content to a subscriber terminal. The broadcast service may be may be a Satellite Digital Audio Radio Service (SDARS) currently providing broadcast audio in the United States or the like or a Digital Audio Broadcasting (DAB) service providing audio broadcasts in Europe and other parts of the world or the like. The MS 110 in this exemplary embodiment has a broadcast receiver for receiving broadcast services such as from the SDARS or DAB service.

Continuing with FIG. 1, the Packet Data Network 190 is communicably coupled to a broadcast subscription management entity which in this exemplary embodiment is a Broadcast Subscription Management Server (BSMS) 195 and to a Broadcast Network Operator (BNO) 187. The BSMS 195 establishes a subscription with the BNO 187 and may subsequently query it for a current shared secret key (shared secret) associated with the user's subscription. The BNO 187 has broadcast transmission entities which in this exemplary embodiment are satellites, in particular a first satellite 188 and a second satellite 189 that are communicably coupled to the ground-based BNO 187 by a wireless link. The broadcast entity or entities may also be a land based transmitter having wired connection or an antenna which may be positioned on a tower or elevated structure for example. The BNO 187 may be part of the PLMN 102 or may be a separate entity, as in this exemplary embodiment, coupled to the PLNM 102 through internet, phone, cable or other like connections. Some networks have communication channels designated for broadcast transmissions, i.e. short message service cell broadcast.

The GSM communications network 100 architecture of FIG. 1 is only an exemplary embodiment and not intended to limit the invention. The inventions apply more generally to any communications networks that provide a bidirectional link to a BNO 187, including, for example, Third Generation (3G) Universal Terrestrial Radio Access Network (UTRAN), Fourth Generation communications networks, and among other existing and future communications network and systems. These and other networks may provide the communication link with the BNO 187 in order to manage the broadcast service subscription. For example, the MS 110 may be communicating with a wireless local area network (WLAN) such as an 802.11 access point or the like or a wide area network (WAN) such as the cellular radiotelephone networks, WiMax (802.16) or the like.

According to one aspect of the exemplary embodiments, a subscription request is transmitted from the MS 110, the subscription request having a subscriber identity and a radio receiver identification (RRID), to the network 102 in which the mobile station 110 is communication with. In this embodiment, the subscriber identity may be an International Mobile Subscriber Identity (IMSI) or the like. The IMSI in this embodiment is stored on a subscriber identify module (SIM) card which is removable from the MS 110. The MS 110 transmits the request, which is in the form of a message in some networks, to one or more BTS 120 located in or communicating with the wireless communications network 102. In response, the MS 110 receives a code or current shared secret key from the network and authenticates a radio receiver of the MS 110 which is associated with the radio receiver identification. The radio receiver that receives the broadcast information may also be referred to herein as the broadcast radio receiver or broadcast receiver hardware.

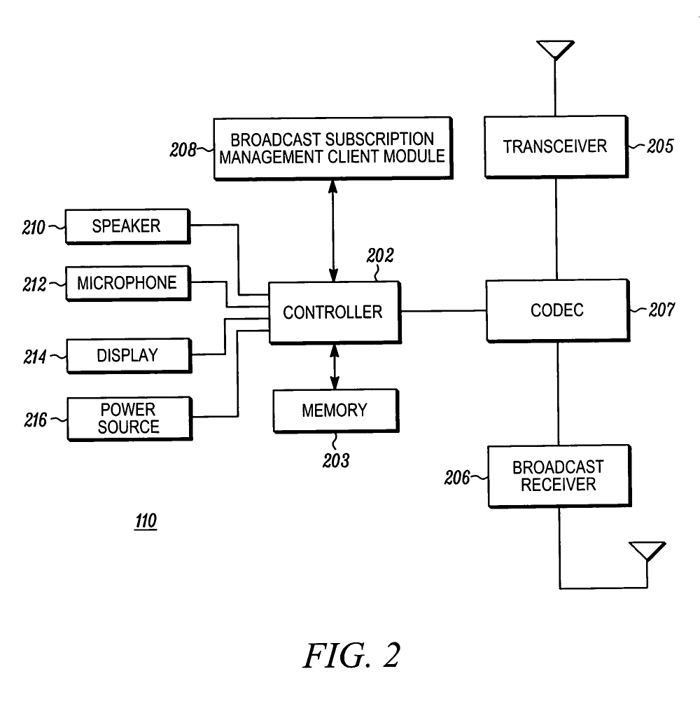

FIG. 2 illustrates an exemplary MS 110 that has the capability to communicate in a network, such as the exemplary GSM cellular network 100, and the capability to receive broadcast services, such as from the exemplary BNO 187. The MS 110 comprises a controller 202, a memory 203 coupled to the controller 202, a transceiver 205 coupled to the controller 202, and a broadcast receiver 206 coupled to the controller 202. In one exemplary embodiment, a CODEC 207 is coupled to the controller 202 for coding and decoding information sent from and received by the MS 110.

A broadcast subscription management entity of the MS 110 which is a broadcast subscription management client module 208 in this embodiment, is coupled to the controller 202. In one exemplary embodiment, the broadcast subscription management client module 208 is a program or algorithm or code segment that is stored in memory and executed therefrom by the controller 202. In another exemplary embodiment, the broadcast subscription management client module 208 is a separate entity coupled to the controller and may have its own memory (not shown). The memory 203 is capable of storing a broadcast radio receiver ID (RRID), an encryption key (also referred to herein as the current shared secret key) and a subscription request.

In the present embodiment, the broadcast subscription management server 197 is a system having an application that executes in the home network operator's environment, and has access to the Internet. The MS 110 has the corresponding broadcast subscription management client 208 application that may initiate a broadcast subscription request and may maintain the subscription across multiple user terminal devices by exchanging information with the broadcast subscription management server 197. The application parts (both the client 208 and server 197) exchange information over the PLMN 102 General Packet Radio Service (GPRS), and therefore roaming, from network to network, is enabled by connection of the broadcast subscription management server 197 to the Internet by the home PLMN 102. In an alternate exemplary embodiment, the broadcast subscription management server 197 is connected to an internal network of a PLMN, the server 197 having a special address which would not be visible outside of the home PLMN and would disable roaming to a visiting network if desired.

The MS 110 of the exemplary embodiment may also include a user interface which may include a speaker 210 a microphone 212 a display or the like. The MS 110 also includes a power source 216.

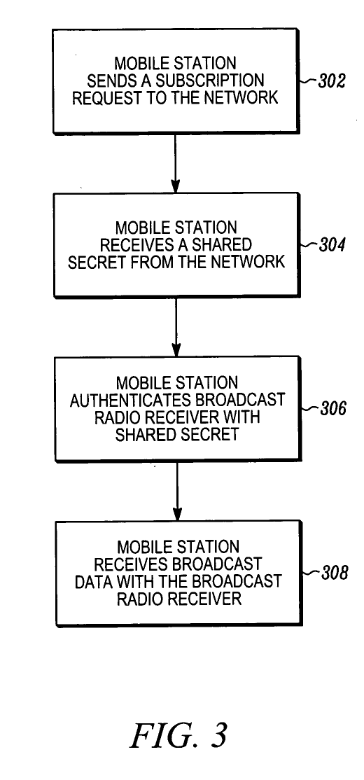

FIG. 3 illustrates an exemplary method for broadcast service subscription management in the mobile station 110. The exemplary method includes transmitting 302 a subscription request from a mobile station 110, the subscription request including a subscriber identity the IMSI in this exemplary embodiment and a radio receiver identification (RRID) of the broadcast receiver 206 in the MS 110, to a network 102. The subscription request may have a broadcast service provider ID, indicating to the broadcast subscription management server 197 which BNO 187 to send the request to.

Next, the MS 110 receives 304 a current shared secret from the network and then authenticates 306 the broadcast radio receiver of the MS 110 with the shared secret. Authentication of the receiver may be enabling the receiver, enabling the decoder coupled to the receiver allowing access to data received by the receiver, or the like. With the authenticated receiver, the MS 110 may receive 308 broadcast data from the broadcast service provider (e.g. the BNO 187). In one exemplary embodiment, the MS 110 receives 308 the broadcast data over a broadcast frequency from the BNO 187. The broadcast data may also be broadcast through the PLMN 102 on a PLMN broadcast channel according to another embodiment. For example, in the exemplary GSM communication network, the Broadcast Control Channel (BCCH), Packet Broadcast Control Channel (PBCCH) and/or General Packet Radio Service (GPRS) Packet Data Traffic Channel (PDTCH) may be used to broadcast data.

The MS 110 may also respond to the receipt of the current shared secret key by sending an acknowledgement of the receipt of the current shared secret key (or broadcast data from a broadcast satellite) to a broadcast subscription management server 197. For example, the mobile station, responsive to receipt of a shared secret key enabling the MS 110 to decode downlink broadcast data, sends an acknowledgement to the broadcast subscription management service entity. The broadcast subscription management service entity, responsive to the receipt of acknowledgement from the MS 110, sends a corresponding acknowledgement to the BNO 187. The BNO 187, responsive to the receipt of acknowledgement from the broadcast subscription management service, invalidates the shared secret keys for any previous hardware device or RRID on which the MS 110 user may have been previously registered.

In addition to authenticating the broadcast radio receiver of the MS 110, the broadcast data may be decoded at the MS 110 with the shared secret key. The CODEC 207 which is coupled to the controller 202 of MS 110 may be used to decode the incoming information broadcast from the BNO 187. The controller 202 tunes the broadcast radio receiver 206 to the broadcast radio frequency of the BNO 187 and a decoder decodes the received broadcast data using the current shared secret key. In one exemplary embodiment, authenticating and decoding is performed by the broadcast management client module 208 of the MS 110.

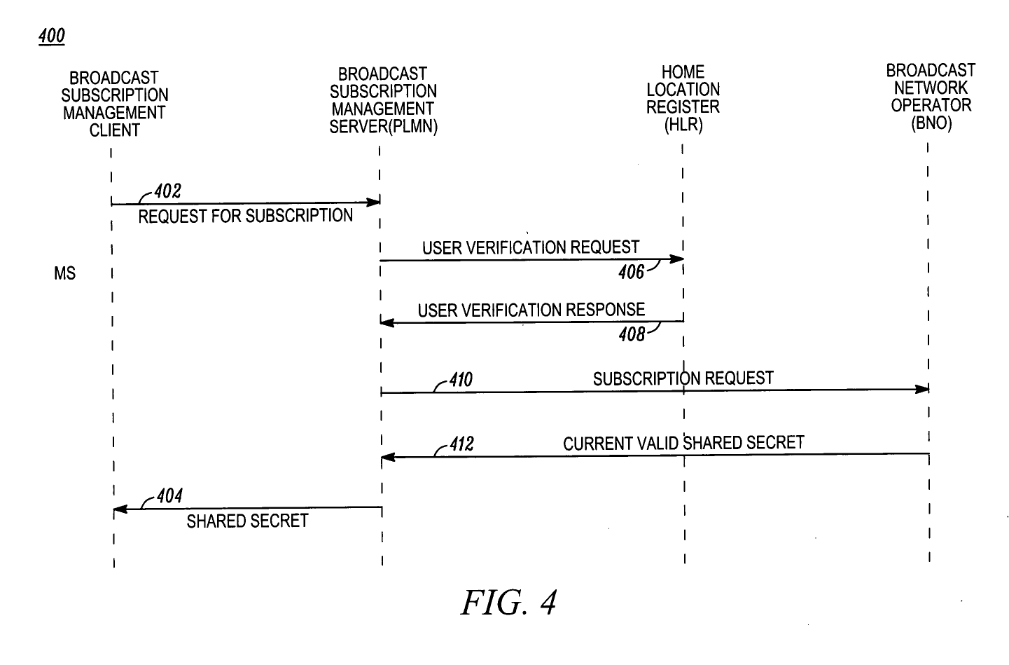

FIG. 4 illustrates an exemplary communications exchange 400 between a broadcast subscription management client of the MS 110, and the broadcast subscription management server 195 of the network 102 in which a subscription request message and response thereto are communicated between the MS 110 and network. The MS 110 sends 402 the subscription request, and the network responds 404 with a current shared secret key in response. The current shared secret is currently active or valid in that it has not expired or has not been cancelled or invalidated or has not been known to be compromised.

Once the network receives 402 the subscription request, the broadcast subscription management server 195 sends 406 a user verification request to the HLR 182. The purpose of this action is to verify the authenticity of the MS 110 user as a user of the Public Land Mobile Network (PLMN), because the HLR 182 has previously authenticated the user and has a record of this information stored therein. Once the MS 110 user has been verified as a user of the PLMN, the HLR 182 sends 408 a user verification response to the BSMS 195. The BSMS 195 sends 410, upon successful user verification at the HLR, a subscription request to the BNO 187. In this exemplary embodiment, the subscription request includes a request identifier, an MS 110 subscriber identifier such as an International Mobile Subscriber Identity (IMSI) and a Radio Receiver Identifier (RRID). The BNO 187 responds 412 with a current shared secret key. The BNO 187 will associate the information received in the subscription request with the current shared secret key also known as a current active shared secret key. The BNO 187 may also respond with a plurality of shared secret keys, or a list thereof, wherein some shared secret keys are to be used in the future by the BSMS 195 to respond to subsequent or future subscription request by the MS 110. Once the BSMS 195 receives 412 the current active shared secret key, or plurality of shared secret keys, or current and future shared secret keys, the BSMS 195 passes 404 the current shared secret key on to the RAN 130 of the PLMN to be transmitted to and used by the MS 110.

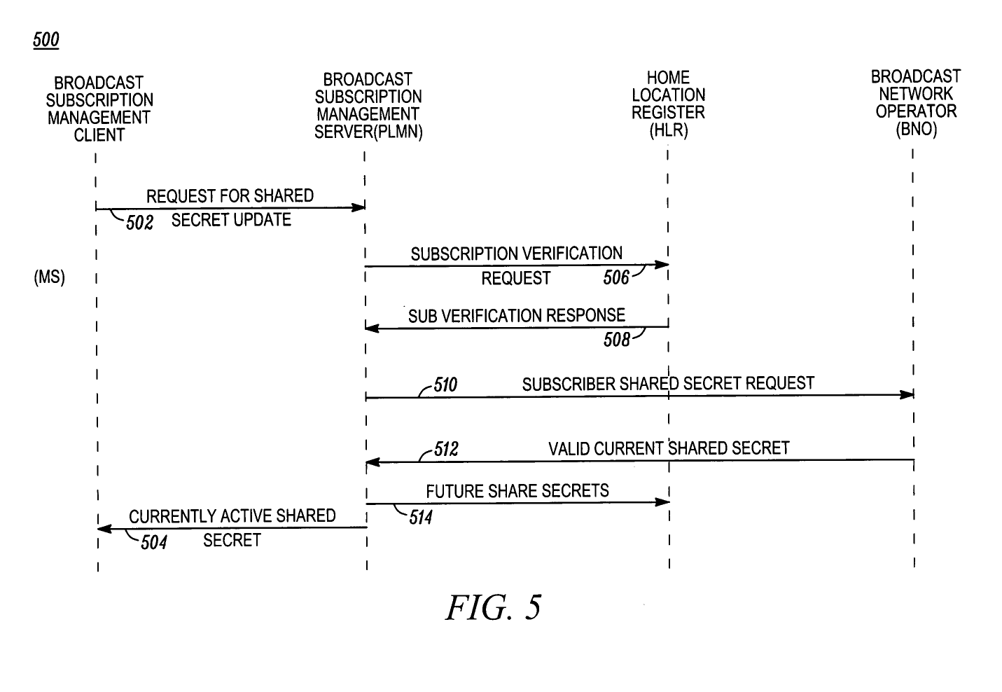

FIG. 5 illustrates an exemplary communications exchange 500 between a broadcast subscription management client 208 of the MS 110, and the broadcast subscription management server 195 of the network 102 in which a shared secret key update request message and response thereto are communicated between the MS 110 and network 100. The MS 110 sends 502 a request for a shared secret key update and the network responds 504 with a currently active shared secret key. After receiving the request 502 and before sending the response 504, the BSMS 195 sends 506 a subscription verification request [IMSI+RRID] to the HLR 182. If the subscription is valid and the HLR 182 has the current valid future shared secret keys, the HLR 182 sends 508 the subscription verification response and a current shared secret key to the BSMS 195.

If the subscription is valid but the HLR 182 does not have the current shared secret key or a list of a plurality of shared secret keys, the BSMS 195 sends 510 a subscriber shared secret key request to the BNO 187. In this exemplary embodiment, the request comprises the IMSI and RRID as discussed above. The BNO 187 will respond by sending 512 the valid current shared secret keys to the BSMS 195. If the BNO 187 sends valid future shared secret keys to the BSMS 195, the BSMS 195 sends 514 the valid future shared secret keys to the HLR 182 for future use. The BSMS 195 also responds 504 to the MS 110 with the current/active shared secret key.

In one exemplary embodiment, a user initially requests a broadcast subscription by pointing a browser of the MS 110 to the address of an application which in part at least has the function of requesting the subscription or managing the shared secret keys in order to establish or maintain the subscription. The application may be the broadcast subscription client module which interacts with the browser application.

In a security-related feature, i.e. ensuring that the subscription is received by the intended recipient subscriber or user terminal, is provided by the process of authentication of the MS 110 by the communication network 100. Once the MS 110 is authenticated within the communication network, the subscription request may be sent on to the BNO 187. For example, the MS 110 is authenticated using the subscriber identity module (SIM) or universal subscriber identity module (USIM) authentication and security features of the exemplary GSM system. The exemplary method includes authenticating the mobile station using a SIM/USIM authentication and security feature indicating to the network operator that this is a valid mobile station requesting a subscription by verification with the Home Location Register (HLR). Another exemplary method authenticates the MS 110 by checking the internal return IP address indicating to the network operator that this is a valid mobile station requesting a subscription by verification with the Home Location Register (HLR). Once authenticated, the MS 110 may inform the MSBS 195 of its IMSI or other identity (which is also known by the home PLMN by way of the HLR) and the Subscription Broadcast Service Radio Receiver Identifier (RRID).

In this exemplary embodiment, these data, exchanged between the MS 110 and the network may all be communicated over GPRS, e.g. over the packet data traffic channel (PDTCH). The Broadcast Subscription Management Client is an application that communicates over IP transport.

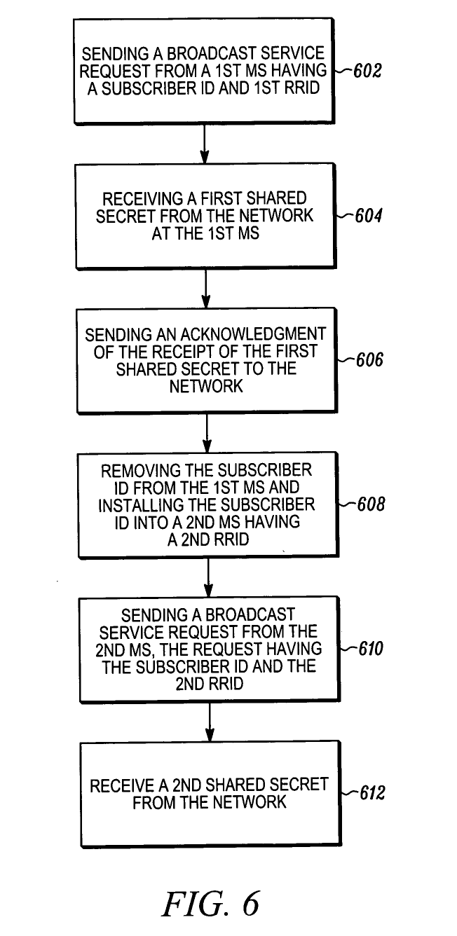

FIG. 6 illustrates an exemplary method of transferring a broadcast subscription from one terminal to another (e.g., from one mobile station to another mobile station). First, a first MS, which may be the MS 110 of the exemplary GSM communication system 100, sends 602 a broadcast subscription request from the first MS to the network, the request including a subscriber ID and a first radio receiver ID associated with a broadcast radio receiver of the first MS. The first MS 110 receives 604 a first shared secret key from the network. The first MS sends 606 an acknowledgment of the receipt of the first shared secret key to the network, which passes the acknowledgment onto the BSMS 195 and then onto the BNO 187. The subscriber may then receive broadcast data from the BNO 187.

Next the subscriber ID is transferred 608 from the first MS to a second MS. The second MS has a second broadcast radio receiver and a second radio receiver ID associated therewith. The second MS requests broadcast service by sending 610 a broadcast service request from the second MS, wherein the request has the subscriber ID and the second RRID. The second MS receives 612 a second shared secret from the network. The second shared secret key may be received from the BNO 187 or from the MSBS 195 as discussed above in accordance with FIG. 5 and the associated description thereof. The subscriber ID may be an IMSI stored in memory, on a SIM card, or the like. The SIM card is removed from the first MS and installed in the second MS thereby transferring the subscriber ID.

The broadcast subscription request may be initiated by the second MS by automatically sending the subscriber ID (e.g., the IMSI) and the second radio receiver ID upon the occurrence of a predetermined event such as upon power up of the second MS or other criteria set in the device. (Alternately, the request may be made when a user launches an application that utilizes broadcast data. In this exemplary embodiment, part of the application execution or startup includes generating and sending the broadcast service request to the network to be routed to the BNO 187. For example, when a user selects the application for listening to an XM® satellite radio broadcast, a software segment generates the broadcast subscription request and the request is sent to the network.

In one exemplary embodiment, upon removal of the subscriber ID or SIM card from the MS the first current shared secret key is invalidated in the MS. The first current shared secret key may be invalidated by deleting the first current shared secret key or flagging the first current shared secret key to indicate invalidity. Alternately, a message may be sent from the BNO 187 to the MSBS 195 indicating that the first current shared secret key has been invalidated. When the second MS sends the request for service, the MSBS 195 may also invalidate the first current shared secret key of the first MS. The MSBS 195 then sends the next valid shared secret key that is associated with the subscriber ID when a broadcast subscription request is made.

The second MS may check for a current shared secret key stored on the second MS; if none is available or when an expired or invalid shared secret is found on the second MS, the broadcast subscription management client 208 will generate the new request.

While the present inventions and what are considered presently to be the best modes thereof have been described sufficiently to establish possession by the inventors and to enable those of ordinary skill to make and use the inventions, it will be understood and appreciated that there are equivalents to the exemplary embodiments disclosed herein and that many modifications and variations may be made thereto without departing from the scope and spirit of the inventions, which are to be limited not by the exemplary embodiments but by the claims appended hereto.

What is claimed is:

1. A method for broadcast service subscription management in at least one mobile station comprising:
transmitting a broadcast subscription request from a first mobile station, the broadcast subscription request including a subscriber identity and a first radio receiver identification to a network in which the mobile station is in communication with;
receiving a first shared secret key at the mobile station from the network; and
authenticating a broadcast radio receiver of the mobile device which is associated with the radio receiver identification with the shared secret key.

2. The method according to claim 1, comprising transmitting the subscriber identity and a second radio receiver identification of a second broadcast radio receiver.

3. The method according to claim 1, comprising receiving broadcast data from a broadcast network operator with the authenticated first broadcast radio receiver of the first mobile station.

4. The method according to claim 2, comprising receiving broadcast data from a broadcast network operator with the second broadcast radio receiver of a second mobile station.

5. The method according to claim 1, comprising decoding broadcast data received from the broadcast service provider with the authenticated first broadcast radio receiver of the first mobile station.

6. The method according to claim 4, comprising decoding broadcast data received from the broadcast service provider with the authenticated second broadcast radio receiver of the second mobile station.

7. The method according to claim 1, wherein the step of transmitting further includes sending the subscription request to a broadcast subscription management server coupled to the network.

8. The method according to claim 1, comprising sending an acknowledgement of the receipt the current shared secret key from the broadcast network operator.

9. The method according to claim 4, comprising sending an acknowledgment of the receipt of the broadcast data from a broadcast satellite to a broadcast subscription management server.

10. The method of claim 1, comprising transmitting a broadcast network operator ID as a component of the broadcast subscription request.

11. The method according to claim 1, comprising receiving the shared secret key at the mobile station from a broadcast subscription management server of the network.

12. The method according to claim 1, wherein the subscriber identification comprises an International Mobile Subscriber Identity (IMSI).

13. The method according to claim 1, comprising authenticating the mobile station using a subscriber identity module authentication and security feature indicating to the network operator that the mobile station is valid.

14. The method according to claim 1, comprising requesting a subscription by verification with the Home Location Register (HLR).

15. The method according to claim 1, comprising authenticating the mobile station by checking the internal return IP address indicating to the network operator that this is a valid mobile station requesting a subscription by verification with the Home Location Register (HLR).

16. The method of according to claim 2, comprising invalidating the first shared secret key at the first mobile station.

17. The method of according to claim 2, comprising installing a removable identity card which includes the subscriber identification into a second mobile device including a second broadcast radio receiver having a second radio receiver identification; and
requesting broadcast services through the communication network by sending the subscriber identity, stored on the removable identity card carried in the second mobile station, and a second radio receiver identification of the second broadcast radio receiver of the second mobile station.

18. The method according to claim 1, comprising sending a first shared secret key, of the plurality of shared secret keys, to a first mobile station having a subscriber identity module with the subscriber identity and a first radio receiver identification; and
invalidating the first shared secret key when the subscriber identification is associated with a second radio receiver identification.

19. A wireless communication device comprising:
a controller;
a wireless communication transceiver coupled to the controller and configured to communicate with a wireless communication network;
a broadcast receiver coupled to the controller having a radio receiver identification associated therewith, the broadcast receiver configured to receive broadcast subscription services; and
a broadcast management client module coupled to the controller, the transceiver and the broadcast receiver, wherein the broadcast management client module is configured to receive a shared secret key from the wireless communication transceiver and to receive information broadcast services.

20. The device according to claim 1, wherein the broadcast management client module is configured to generate a broadcast service request message.

21. The device according to claim 1, wherein the broadcast management client module is configured to generate a broadcast service data received acknowledgement message.

22. The device according to claim 1, wherein the broadcast management client module is further configured to decode information received from the broadcast network operator.

23. The device according to claim zz4, wherein the broadcast management client module is further configured to decode the information received with a current shared secret key.

24. A method for broadcast service subscription management in a wireless communication network comprising:
receiving a broadcast subscription request from a mobile station, the broadcast subscription request including a subscriber identity and a first radio receiver identification;
sending the subscription request to a broadcast network operator; and
receiving at least one shared secret key from the broadcast network operator, wherein the shared secret key is associated with the subscriber identity and the first radio receiver identification; and
transmitting the at least one shared secret key to the mobile station.

25. The method according to claim 24, associating the subscription request with the subscriber identity at a broadcast subscription management server.

26. The method according to claim 24, associating the subscription request with the subscriber identity at the home location register.

27. The method according to claim 24, storing the subscriber identity, the subscription request, and the current shared secret key at the broadcast subscription management server.

28. The method according to claim 24, storing a plurality of shared secret keys received from the broadcast network operator at the home location register.

29. The method according to claim 28, selectively sending to the mobile station a secret key of the plurality of shared secret keys in response to receiving a new subscription request from the subscriber identity and a second RRID.
